(19) United States
(12) Patent Application Publication
(10) Pub. No.: US 2023/0325469 A1
(43) Pub. Date: Oct. 12, 2023

(54) DETERMINING ANALYTICAL MODEL ACCURACY WITH PERTURBATION RESPONSE

(71) Applicant: International Business Machines Corporation, Armonk, NY (US)

(72) Inventors: Yair Zvi Schiff, New York, NY (US); Brian Leo Quanz, Yorktown Heights, NY (US); Payel Das, Yorktown Heights, NY (US); Pin-Yu Chen, White Plains, NY (US)

(21) Appl. No.: 17/715,684

(22) Filed: Apr. 7, 2022

(51) Int. Cl. G06K 9/62; G06N 20/00

(52) U.S. Cl. CPC G06K 9/6262; G06K 9/6201; G06N 20/00

(57) ABSTRACT

One or more systems, devices, computer program products and/or computer-implemented methods of use provided herein relate to classifying accuracy of analytical model, such as a neural network. A system can comprise a memory that stores computer executable components, and a processor that executes the computer executable components stored in the memory, wherein the computer executable components can comprise an accessing component that accesses an analytical model, a deviation component that generates combined results of the analytical model in response to a set of inputs that vary in degree of perturbation of a set of test data, and an analysis component that compares a range of the combined results to a range of the ideal results.

### BACKGROUND

In the field of analytical modeling, analytical models can be employed to provide analysis, prediction, estimation, statistics and/or the like. Such analytical models can be, comprise and/or be comprised by classical models, such as predictive models, neural networks, and/or artificial intelligent models. Artificial intelligent models and/or neural networks can comprise and/or employ artificial intelligence (AI), machine learning (ML), and or deep learning (DL), where the learning can be supervised, semi-supervised and/or unsupervised.

Generally, such analytical models are trained on a set of training data that can represent the type of data for which the system will be used. Different analytical models can have different accuracies relative to data that is output by the analytical model. Such accuracy can be quantized as compared to ideal and/or known results of a training set of data.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatuses and/or computer program products can facilitate a process to analyze accuracy of an analytical model as compared to an idealized model.

In accordance with an embodiment, a system can comprise a memory that stores computer executable components, and a processor that executes the computer executable components stored in the memory, wherein the computer executable components can comprise an accessing component that accesses an analytical model, a deviation component that generates combined results of the analytical model in response to a set of inputs that vary in degree of perturbation of a set of test data, and an analysis component that compares a range of the combined results to a range of the ideal results.

In accordance with another embodiment, a computer-implemented method can comprise accessing, by a system operatively coupled to the processor, an analytical model. The method can further comprise generating, by the system, combined results of the analytical model in response to a set of inputs that vary in degree of perturbation of a set of test data, and comparing, by the system, a range of the combined results to a range of the ideal results.

In accordance with yet another embodiment, a computer program product facilitating a process to classify accuracy of an analytical model can comprise a computer readable storage medium having program instructions embodied therewith, the program instructions executable by a processor to cause the processor to access, by the processor, the analytical model, generate, by the processor, combined results of the analytical model in response to a set of inputs that vary in degree of perturbation of a set of test data, and compare, by the processor, a range of the combined results to a range of the ideal results.

### DESCRIPTION OF THE DRAWINGS

FIG. 1 illustrates a block diagram of an example, non-limiting system that can facilitate analytical model classification, in accordance with one or more embodiments described herein.

FIG. 2 illustrates a block diagram of another example, non-limiting system that can facilitate analytical model classification, in accordance with one or more embodiments described herein.

FIG. 3 illustrates a high-level schematic diagram of an example method of analytical model classification, in accordance with one or more embodiments described herein.

FIG. 4 depicts a graph illustrating a general process of analytical model classification in accordance with one or more embodiments described herein.

FIG. 5 depicts a graph of perturbation response curve output from an analytical model, in accordance with one or more embodiments described herein.

FIG. 6 depicts a block diagram of an example, non-limiting system that can facilitate analytical model classification, in accordance with one or more embodiments described herein.

FIG. 7 illustrates a process flow for facilitating analytical model classification, in accordance with one or more embodiments described herein.

FIG. 8 illustrates a block diagram of an example, non-limiting, operating environment in which one or more embodiments described herein can be facilitated.

FIG. 9 illustrates a block diagram of an example, non-limiting, cloud computing environment in accordance with one or more embodiments described herein.

FIG. 10 illustrates a block diagram of example, non-limiting, abstraction model layers in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Analytical models, such as neural networks, have produced state-of-the-art and human-like performance across a variety of tasks. As used herein, analytical models can be, be comprised by and/or comprise predictive models, neural networks, other deep learning models, machine learning models, AI models and/or the like. Given prevalence and increasing applications of such analytical models, it can be desired to estimate how well a trained analytical model will generalize and/or how well a trained analytical model will respond relative to one or more individual and/or combined variables. For example a task can desire for a model to be invariant to one or more transformations and/or perturbations of data. This can be achieved through data augmentation that changes underlying statistics of training sets of data or through inductive architectural biases, such as translation invariance that can be inherent in convolutional neural networks, for example.

That is, such analytical models are trained on a set of training data that can represent the type of data for which the system will be used. Different analytical models can have different accuracies relative to data that is output by the analytical model. Such accuracy can be quantized as compared to ideal and/or known results of a training set of data. There remains a desire for efficient, differentiable and/or intuitive measure that can predict generalization given a trained analytical model and its corresponding data post hoc.

Generally a framework is described herein that comprises building an estimate of how accuracy of a model changes as a function of varying levels of perturbation present in training data. The analytical model can be evaluated on a subset of the training data, which has been perturbed to some degree, to determine an accuracy of the analytical model. Using one or more observations of accuracy versus perturbation magnitude (e.g., degree), a perturbation response (PR) curve can be generated for the analytical model. From the PR curve, deviation measures (e.g., deviation scores) can be derived, including a Gi-score and a Pal-score, which compare a given analytical model's PR curve to that of an idealized analytical model that is unaffected by all perturbation magnitudes. The deviation scores thus can allow for a measure of invariance of an analytical model to one or more given perturbations.

As used herein, ideal results are output from an idealized model that is unaffected by all perturbation magnitudes.

In one or more embodiments, this framework can be applied to inter and intra class mix-up perturbations, such as any parametric perturbation (e.g., parametric transformation). Perturbing of data can thus comprise application of a parametric transformation to all or a portion of test data of a training set of data (e.g., where the test data is a portion of the full training data set on which the analytical mode is run to measure accuracy of the analytical model). Relative to perturbing test/training data by applying one or more parametric transformations, consistent prediction on invariant data transformations can be a desired property for analytical models and can be used as a data augmentation or regularization tool during training for improving generalization.

Described herein are one or more embodiments of a system, computer-implemented method and/or computer program product that can classify an analytical model based perturbation to relevant training data. Test data employed can be a range of a set of training data, such as less than a full set of training data. The perturbation can be of the full set of test data or of one or more individual and/or combined variables. The perturbation can comprise use of one or more transformations, such as parametric transformations, Gaussian noise, interpolation perturbation, intra-class perturbation and/or inter-class perturbation.

In response, the one or more embodiments described herein can output one or more deviation scores that provide comparison to an ideal model. As used herein, the ideal model can be one that returns known and exact results, where results returned form a typical analytical model can have some level of deviation relative to the known and exact results. The deviation scores can provide an account of generalized accuracy of an analytical model or an account of how invariant an analytical model is to perturbation of one or more individual and/or combined variables. As used herein, a variable can be an attribute, factor, condition, quantity and/or the like.

The difference between known/ideal results and returned results, such as based on varying degrees of perturbation of test data, can be graphable for easy visual comparison. The perturbation can comprise employment of one or more parametric transformations. As used herein, a parametric transformation can convert from projected coordinates to projected coordinates, such as without moving through geodetic coordinates. Areas under the curves, whether or not actually visually graphed, can be employed to provide classification of an analytical model relative to a perfect and/or ideal model. Further, such data/results can provide for comparison between different models and/or between different degrees of perturbation of one or more models.

One or more embodiments are now described with reference to the drawings, where like referenced numerals are used to refer to like elements throughout. As used herein, the terms “entity”, “requesting entity” and “user entity” can refer to a machine, device, component, hardware, software, smart device and/or human. In the following description, for purposes of explanation, numerous specific details are set forth in order to provide a more thorough understanding of the one or more embodiments. It is evident, however, in various cases, that the one or more embodiments can be practiced without these specific details.

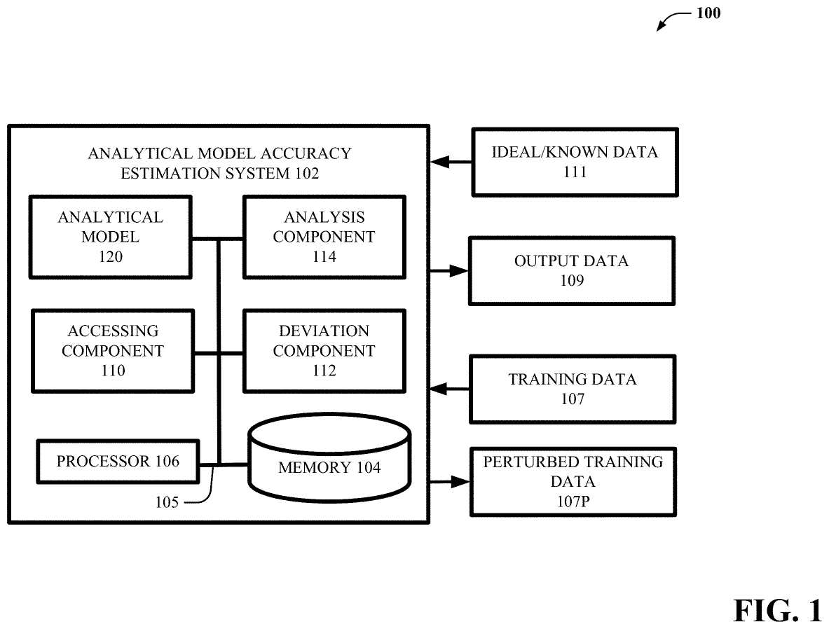

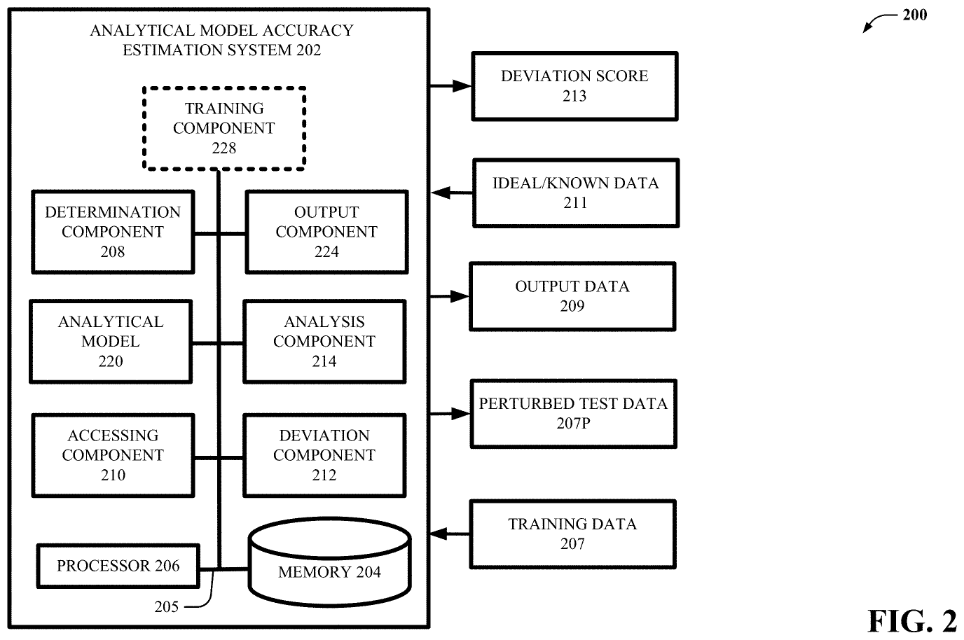

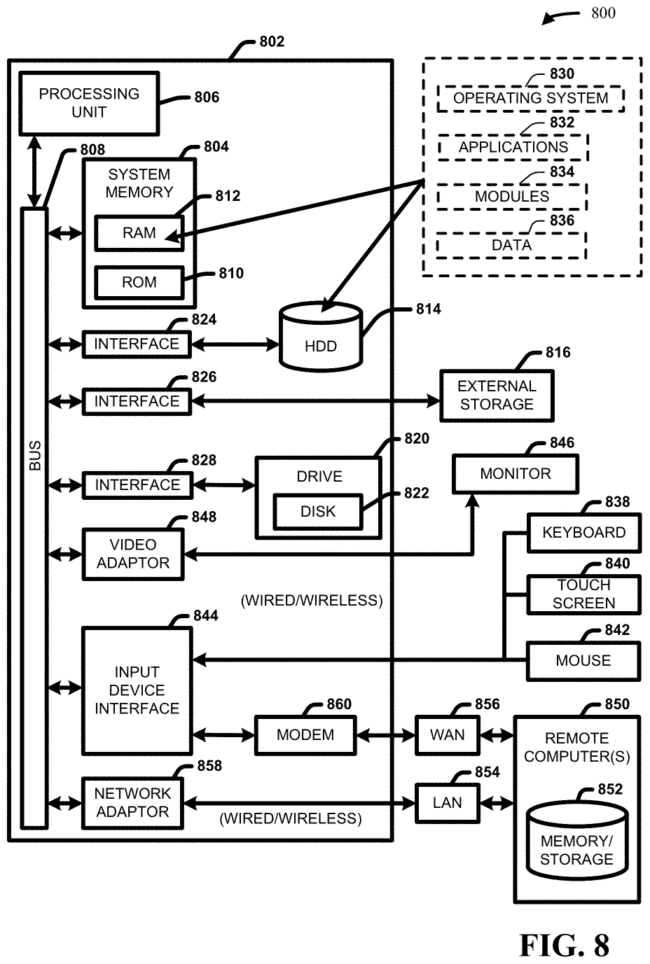

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100 and/or 200 as illustrated at FIGS. 1 and 2, and/or systems thereof, can further comprise, be associated with and/or be coupled to one or more computer and/or computing-based elements described herein with reference to an operating environment, such as the operating environment 800 illustrated at FIG. 8. In one or more described embodiments, computer and/or computing-based elements can be used in connection with implementing one or more of the systems, devices, components and/or computer-implemented operations shown and/or described in connection with FIGS. 1 and/or 2 and/or with other figures described herein.

Turning first generally to FIG. 1, one or more embodiments described herein can include one or more devices, systems and/or apparatuses that can facilitate classification of accuracy of an analytical model, in accordance with one or more embodiments described herein. While referring here to one or more processes, facilitations and/or uses of the non-limiting system 100, description provided herein, both above and below, also can be relevant to one or more other non-limiting systems described herein, such as the non-limiting system 200, to be described below in detail.

As illustrated at FIG. 1, the non-limiting system 100 can comprise an analytical model accuracy estimation (AMAE) system 102. AMAE system 102 can comprise one or more components, such as a memory 104, processor 106, bus 105, accessing component 110, deviation component 112, analysis component 114 and/or analytical model 120. Generally, AMAE system 102 can facilitate, in response to perturbation of training data 107, a measure of accuracy of the analytical model 120 relative to the perturbed training data 107P.

As used herein, an analytical model can be, be comprised by and/or comprise predictive models, neural networks, deep neural networks, convolutional neural networks, machine learning models, AI models, deep learning models and/or the like.

Without being limited thereto, the analytical model 120 can be predictive and/or employ AI, ML, DL, natural language processing (NLP), image recognition and/or the like.

The analytical model 120 is illustrated as part of the AMAE system 102, but in one or more other embodiments, can be disposed external to, and thus accessible to, the AMAE system 102. For example, in such case, an input/output component (e.g., accessing component 110) of the AMAE system 102 can send, transmit, input, obtain and/or retrieve data between the AMAE system 102 and analytical model 120.

The accessing component 110 can generally access the analytical model 120, which can comprise locating and requesting access to the analytical model 120. The accessing component 110 can employ any suitable method of communication, by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

The deviation component 112 can, in response to output from the analytical model 120, generate combined results of the analytical model 120 in response to a set of inputs that can vary in degree of perturbation of a set of test data. The test data can be a range and/or subset of a full set of training data 107. That is, the deviation component 112 can combine and/or align various results from various executions of the analytical model 120 on various set of variously perturbed test data. In one or more cases, the deviation component 112 can graph the combined data, although the graph can or cannot be visually accessible to a user entity.

The analysis component 114 can compare the combined results to ideal results such as from ideal/known data 111. The ideal results can comprise results of an idealized model which is unaffected by perturbations in the test data. In one or more cases, the ideal results can be known and no idealized model is generated and/or executed.

One or more aspects of a component (e.g., the accessing component 110, deviation component and/or the analysis component 114 can be employed separately and/or in combination, such as employing one or more of a memory or a processor of a system that includes the component to thereby facilitate measurement of accuracy of the analytical model 120. That is, these components can employ the processor 106 and/or the memory 104. Additionally and/or alternatively, the processor 106 can execute one or more program instructions to cause the processor 106 to perform one or more operations by these components.

Turning next to FIG. 2, the figure illustrates a diagram of an example, non-limiting system 200 that can facilitate a process for determining a measure of accuracy of generalized use and/or particular use of an analytical model 220, in accordance with one or more embodiments described herein. Repetitive description of like elements and/or processes employed in respective embodiments is omitted for sake of brevity. As indicated previously, description relative to an embodiment of FIG. 1 can be applicable to an embodiment of FIG. 2. Likewise, description relative to an embodiment of FIG. 2 can be applicable to an embodiment of FIG. 1.

As illustrated, the non-limiting system 200 can comprise an analytical model accuracy estimation (AMAE) system 202. Generally, AMAE system 202 can facilitate, in response to perturbation of training data 107, a measure of accuracy of the analytical model 120 relative to the perturbed training data 107P. General operations that can be executed by the AMAE system 202 can comprise, but are not limited to, analytical model execution, results data compilation, results data analysis, results data comparison to ideal data, and/or the like.

The AMAE system 202, as illustrated, can comprise any suitable type of component, machine, device, facility, apparatus and/or instrument that comprises a processor and/or can be capable of effective and/or operative communication with a wired and/or wireless network. All such embodiments are envisioned. For example, AMAE system 202 can comprise a server device, computing device, general-purpose computer, special-purpose computer, quantum computing device (e.g., a quantum computer), tablet computing device, handheld device, server class computing machine and/or database, laptop computer, notebook computer, desktop computer, cell phone, smart phone, consumer appliance and/or instrumentation, industrial and/or commercial device, digital assistant, multimedia Internet enabled phone, multimedia players and/or another type of device and/or computing device. Likewise, the AMAE system 202 can be disposed and/or run at any suitable device, such as, but not limited to a server device, computing device, general-purpose computer, special-purpose computer, quantum computing device (e.g., a quantum computer), tablet computing device, handheld device, server class computing machine and/or database, laptop computer, notebook computer, desktop computer, cell phone, smart phone, consumer appliance and/or instrumentation, industrial and/or commercial device, digital assistant, multimedia Internet enabled phone, multimedia players and/or another type of device and/or computing device.

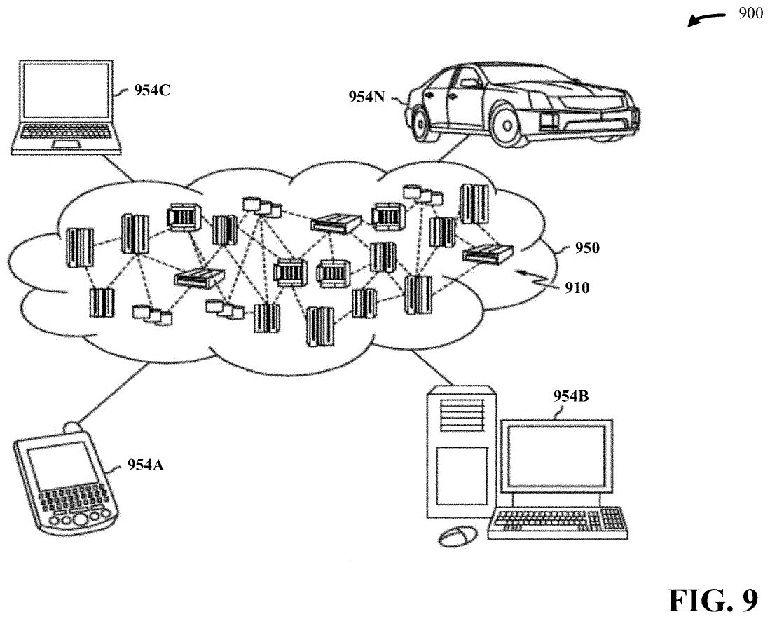

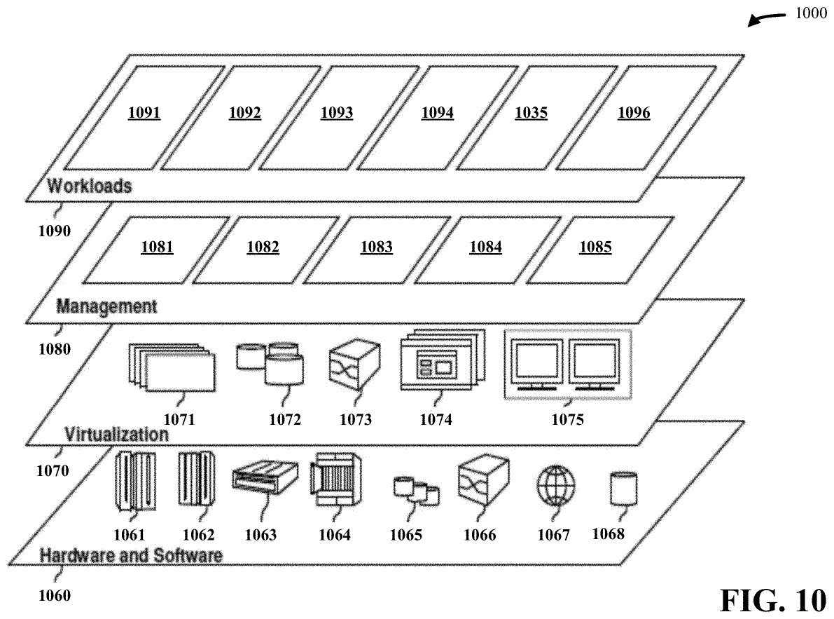

The AMAE system 202 can be associated with, such as accessible via, a cloud computing environment. For example, the AMAE system 202 can be associated with a cloud computing environment 950 described below with reference to illustration 900 of FIG. 9 and/or with one or more functional abstraction layers described below with reference to FIG. 10 (e.g., hardware and software layer 1060, virtualization layer 1070, management layer 1080 and/or workloads layer 1090).

Operation of the non-limiting system 200 and/or of the AMAE system 202 is not limited to analysis of a single model or to analysis of one or more models based on a single set of test data. Rather, operation of the non-limiting system 200 and/or of the AMAE system 202 can be scalable. For example, the non-limiting system 200 and/or the AMAE system 202 can facilitate estimation of accuracy of one or more analytical models, which can be of varying types. Additionally and/or alternatively, the non-limiting system 200 and/or the AMAE system 202 can facilitate estimation of one or more analytical models based on plural perturbations (e.g., of various degrees and/or magnitudes) of test data. These processes can be facilitate at a same time as and/or separately from one another.

The AMAE system 202 can comprise a plurality of components. The components can include a memory 204, processor 206, bus 205, determination component 208, accessing component 210, deviation component 212, analysis component 214 and/or output component 224. Like the AMAE system 102, the AMAE system 202 can be operated to facilitate a process for facilitating accuracy estimation of an analytical model.

One or more communications between one or more components of the non-limiting system 200, and/or between an external system, such as comprising and/or facilitating access to any one or more of a database, log, ideal/known data 211, training data 207, analytical model 220, and/or the non-limiting system 200, can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

Discussion now turns to the processor 206, memory 204 and bus 205 of the AMAE system 202.

For example, in one or more embodiments, AMAE system 202 can comprise a processor 206 (e.g., computer processing unit, microprocessor, classical processor, quantum processor and/or like processor). In one or more embodiments, a component associated with AMAE system 202, as described herein with or without reference to the one or more figures of the one or more embodiments, can comprise one or more computer and/or machine readable, writable and/or executable components and/or instructions that can be executed by processor 206 to facilitate performance of one or more processes defined by such component(s) and/or instruction(s). In one or more embodiments, the processor 206 can comprise determination component 208, accessing component 210, deviation component 212, analysis component 214 and/or output component 224.

In one or more embodiments, the AMAE system 202 can comprise a computer-readable memory 204 that can be operably connected to the processor 206. The memory 204 can store computer-executable instructions that, upon execution by the processor 206, can cause the processor 206 and/or one or more other components of the AMAE system 202 (e.g., determination component 208, accessing component 210, deviation component 212, analysis component 214 and/or output component 224) to perform one or more actions. In one or more embodiments, the memory 204 can store computer-executable components (e.g., determination component 208, accessing component 210, deviation component 212, analysis component 214 and/or output component 224).

AMAE system 202 and/or a component thereof as described herein, can be communicatively, electrically, operatively, optically and/or otherwise coupled to one another via a bus 205 to perform functions of non-limiting system 200, AMAE system 202 and/or one or more components thereof and/or coupled therewith. Bus 205 can comprise one or more of a memory bus, memory controller, peripheral bus, external bus, local bus, quantum bus and/or another type of bus that can employ one or more bus architectures. One or more of these examples of bus 205 can be employed to implement one or more embodiments described herein.

In one or more embodiments, AMAE system 202 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical and/or quantum computing devices, communication devices and/or like devices), such as via a network. In one or more embodiments, one or more of the components of the non-limiting system 200 can reside in the cloud, and/or can reside locally in a local computing environment (e.g., at a specified location(s)).

In addition to the processor 206 and/or memory 204 described above, AMAE system 202 can comprise one or more computer and/or machine readable, writable and/or executable components and/or instructions that, when executed by processor 206, can facilitate performance of one or more operations defined by such component(s) and/or instruction(s).

Turning now to the determination component 208, the determination component 208 can locate, find, search and/or otherwise determine an analytical model to analyze. For example, the determination component 208 can locate the analytical model 220 based on one or more instructions from the processor 206 and/or from a user entity.

The accessing component 212 can receive, download, transfer, upload and/or otherwise obtain the training data 207 and/or ideal/known data 211, such as for initiating one or more predictions by the AMAE system 202.

Likewise, the accessing component 210 can generally access the analytical model 220, which can comprise locating and requesting access to the analytical model 220.

The analysis component 214 can select a subset of the training data 207 to be a set of test data for executing at the analytical model 220. The set of test data can be less than all of the training data 207, such as about 50% of the training data, about 30% of the training data or about 10% of the training data. In this way, less data can be analyzed, thus taking less time, energy, memory, cost and/or the like, while still allowing for an estimation of accuracy of the analytical model 120.

The analysis component 214 can perturb, such as vary, the set of test data. Various degrees of perturbation can be employed (e.g., magnitudes of perturbation). In one or more embodiments, the analysis component 214 can perturb the training data prior to selecting aligned subsets of the resultant perturbed data, although this may take more time, energy, memory, cost and/or the like.

In one or more embodiments, various degrees of perturbation may comprise employing one or more parametric transformations to affect (e.g., transform) the set of test data. In one or more embodiments a perturbation can be selected by the AMAE system 202 and/or a user entity. In one or more embodiments, one or more perturbations, such as transformations and/or the like can be stored internal and/or external to the AMAE system 202.

For example, perturbations relative to an image recognition model can comprise various degrees of focus of images, various degrees of rotation of images, various flippings of images, various colorings of images and/or the like.

Based on the perturbation, the analysis component 214 can output various perturbed sets of test data 207P. That is, the analysis component 214 and/or the processor 206 can execute the analytical model 220 using the various sets of perturbed test data 207P and/or also using an initial unperturbed set of test data that aligns to the perturbed test data 207P. As used herein, alignment refers to use of the same range of test data both initially and for each varying degree of perturbation, such that the results of executions of various input data sets are respectively comparable to one another.

The analytical model 220 can output one or more sets of tests results. In one or more embodiments, the output component 224 can retrieve the test results and function as an intermediary between the analytical model 220 and the deviation component 212. This can particularly be the case where the analytical model 220 is external to the AMAE system 202.

The deviation component 212 can, in response to output from the analytical model 220, generate combined results of the analytical model 220 in response to the various executions with the initial test data and perturbed test data 207P. That is, the deviation component 212 can combine and/or align various results from various executions of the analytical model 220 on various set of variously perturbed test data. In one or more cases, the deviation component 212 can graph the combined data, although the graph can or cannot be visually accessible to a user entity.

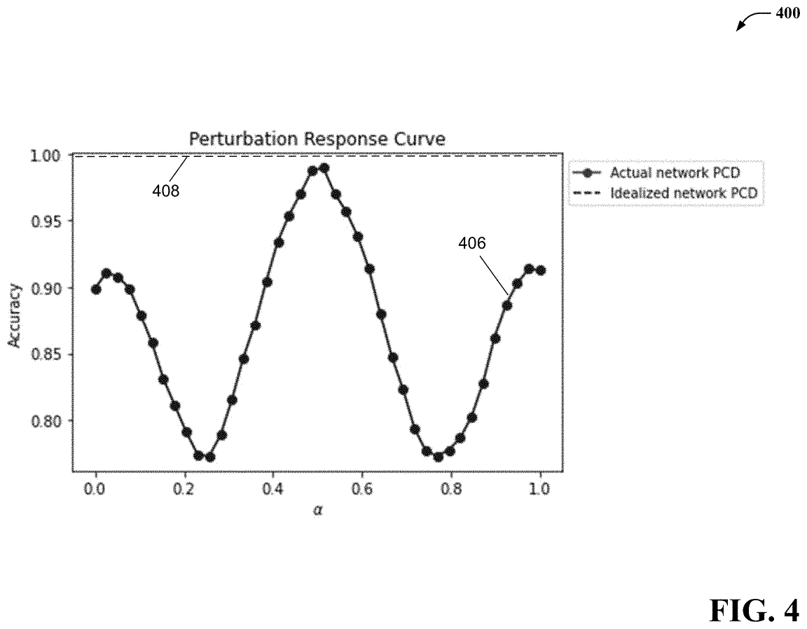

For example, referring to FIG. 4, but also still to FIG. 2, a perturbation response graph 400 is illustrated including a perturbation response (PR) curve 406. The perturbation response graph 400 graphs accuracy of the analytical model 220 against various degrees of perturbation of the set of test data. For example, the particular perturbation response graph 400 at FIG. 4 illustrates degrees of perturbation being degrees of rotation of images. Comparatively, the idealized model has a PR curve that starts and remains at accuracy 1.0, and thus is represented by PR curve 408. Thus in the particular embodiment of FIG. 4, 0.0α represents 0 degrees rotation, 0.5α represented 180 degrees rotation, and 1.0α represents 360 degrees rotation (e.g., back to start/non-rotated). It will be appreciated that different variables perturbed can result in variously shaped PR curves 406. For example, 0.0α can be not equal to 1.0α perturbation in various other perturbation schemes, such as employing a parametric transformation.

In one or more embodiments, a Method 1, including a first set of steps can be employed to build the PR curve 306.

Method 1:

METHOD 1
Building Perturbation Response (PR) Curve

```
Inputs: Trained model ƒ; Dataset [symbol] ; Perturbation [symbol] α; Min perturbation magnitude αₘᵢₙ; Max
      perturbation magnitude αₘₐₓ; Number of perturbation magnitudes to measure nₚ; Layer
      at which to apply the perturbation [symbol] ; number of batches to sample n_{b}; batch size bₛ
Output: PR Curve: Arrays of regularly spaced perturbation magnitudes ranging from αₘᵢₙ to
      αₘₐₓ of length nₚ [αₘᵢₙ, αₘₐₓ][nₚ] and accuracy array at each perturbation magnitude
      of length np [symbol] _{α}[nₚ]
for i ← 0 to nₚ − 1 do
  αₜ ← [αₘᵢₙ, αₘₐₓ][i]
  Shuffle [symbol]
  for k ← to n_{b} − 1 do [symbol]
    sample ← [symbol] [kbₛ : (k + 1)bₛ] / / batch k of [symbol] [symbol]
^{(l)}_{α}_{ₜ}[k] ← batch accuracy under perturbation [symbol] _{α}_{ₜ} (Equation1 ) [symbol]
_{α}[i] ← Σₖ [symbol] ⁽ [symbol] ⁾_{α}_{ₜ}[k]/n_{b}
```

At Method 1, one or more processes can be performed to generate the PR curve 406 of the analytical model. The user entity's provided number of steps, nₚ, dictate how many iterations the algorithm runs. The perturbations range from minimum to maximum perturbation value is split into equally spaced steps; the same number of steps provided by the user. At each iteration of the algorithm a perturbation value can be drawn sequentially from this range. Then a portion of the training/test data can be sampled. This sample of training/test data can be perturbed according to the perturbation type provided by the user and the magnitude of the current iteration. The accuracy of the analytical model on this perturbed sample can be calculated by breaking the sample into batches and accumulating accuracy of the analytical model on each batch of the perturbed sample. A final output of the Method 1 can be an array of accuracies for each perturbation magnitude, the length of which is the same number of steps provided by the user, nₚ.

For example, relative to an analytical model for image recognition, generally, letting τ_{α} refer to image rotation, α (magnitude of perturbation) can be varied from a minimum of α_{Min} degree of rotation to a maximum α_{Max} degree of rotation. For each α, accuracy A_{α}^{(l)} can be calculated to measure the analytical model's response to the perturbation of magnitude α applied at depth l. Plotting accuracy A_{α}^{(l)}, normalized to a 0 to 1 range, on the vertical axis and a on the horizontal axis gives the PR curve.

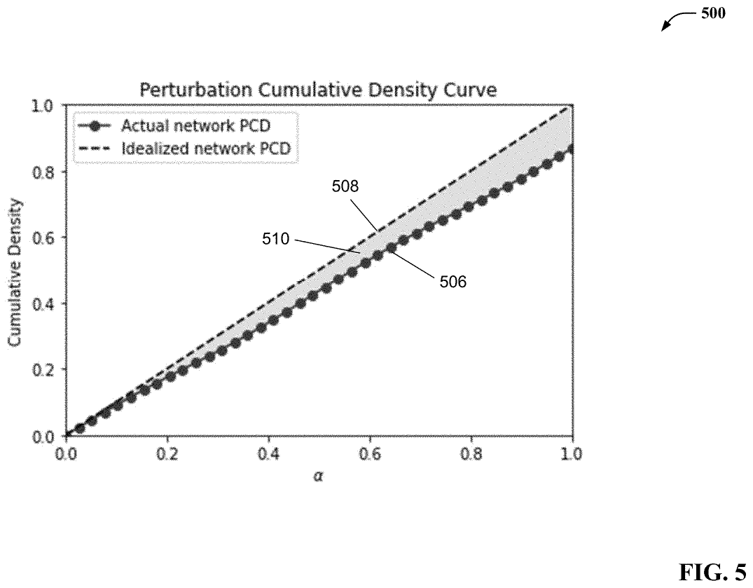

Turning next to FIG. 5 and also still to FIG. 2, the deviation component 212 further can generate a perturbation cumulative density (PCD) graph 500 comprising a PCD curve 506. The PCD graph 500 generally plots the cumulative density integral under the PR curves against the magnitudes αᵢ∈[αₘᵢₙ,αₘₐₓ]:∫₀^{α}^{ᵢ} [symbol] _{α}dα. This produces PCD curves 406 and 408. That is, as used herein, perturbation cumulative density can be defined as cumulative area under the curve at each progressing perturbation magnitude. That is, for each point αi on the horizontal axis from 0 to 1, PCD is the area of the region bounded above by the perturbation response curve and below by the horizontal axis and bounded to the left by the vertical axis & to the right by a vertical line at the point αᵢ.

As illustrated with PCD curve 408, for an idealized model having PR identically equal to 1.0 for all α, the PCD curve 408 is a 45 degree line passing through the origin (0,0). As illustrated with PCD curve 406 of the analytical model 220, cumulative area under the curve

This graph generally can be employed to compare the analytical models cumulative density (PCD curve 506) against a PCD curve of an idealized model (PCD curve 508). As illustrated, the PCD curve 508 of the idealized model has a 45 degree angle and thus a slope of 1. A shaded area 510 between the curves, and particularly the area thereof, can be employed to calculate one or more deviation scores by the analysis component 214.

At Method 2, one or more processes can be performed to generate the PCD curves 506 and 508. It is noted that Method 2 is illustrated below as being comprised by Method 3. That is, the first two “for” loops of Method 3 can be employed to execute respective calculations to generate the PCD curves 506 and/or 508.

Next, the analysis component 214 can compare the combined results to ideal results such as from ideal/known data 211. The ideal results can comprise results of an idealized model which is unaffected by perturbations in the test data. In one or more cases, the ideal results can be known and no idealized model is generated and/or executed.

At Method 3, a first deviation score, a Gi-Score can be determined. A Gi-score can be defined as a ratio of the area 510 between the idealized model's PCD curve 508 and the analytical model's PCD curve 506, and the total area below the idealized model's PCD curve 508.

Method 3:

METHOD 3
Gi-Score computation given PR Curve for a model

Inputs: Arrays of perturbation magnitude α[n] and accuracy [symbol] _{α}[n]
Output: Gi-score gi
αₜ(0) ← 0 / / initialize 1st element of trapezoidal areas array with 0
for 1 ← 0 to n − 2 do
└αₜ[i + 1] ← 0.5(α[i + 1] − α[i])( [symbol] _{α}[i] + [symbol] _{α}[i + 1])
for i ← 1 to n − 1 do
└αₜ[i] ← αₜ[i] + αₜ[i − 1]. / / cumulative sum
d[i] = α[i] − αₜ[i], [symbol] i
gi = 0
for i ← 0 to n − 2 do
└ gi ← gi + 0.5(α[i +1] − α[i])(d[i] + d[i + 1])
gi ← gi/(0.5α(n − 1]²) / / Divide by area under line of equality
return gi [symbol]
indicates data missing or illegible when filed

At Method 3, one or more processes can be performed to generate the Gi-Score, such as by the analysis component 214. In the first ‘for’ loop of this method, the area below the perturbation response curve and bounded between successive points along the horizontal axis is calculated. These areas are then summed up in the subsequent ‘for’ loop to create cumulated densities. Deviation from an ideal network that has perfect (1.0) accuracy is calculated. This gives the area between the idealized network (that has a perturbation cumulative density curve represented by the 45-degree line) and the actual network that is being evaluated. In the final ‘for’ loop the areas between these curves is summed for the entire horizontal axis. The final output is the ratio of this area between the curve and the total area below the idealized network's perturbation cumulative density curve (i.e., the 45-degree line).

At Method 4, a second deviation score, a Pal-score can be determined. A Pal-score can be defined as a ratio of an area for a top index of the area under the PCD curve 506 of the analytical model and an area for a bottom index of the area under the PCD curve 506 of the analytical model. In this way, focus can be provided for variations on upper and lower ends of the perturbation magnitude spectrum, ignoring the middle perturbations. For example, in one or more case, middle perturbations can have less variance across models.

Put another way, in one or more embodiments, less than all of the PCD data can be analyzed. For example, an upper subset and a lower subset can be analyzed, and/or only an upper subset can be analyzed. In one or more examples, the upper subset can comprise about the last 40 percent of data along the x-axis of a respective PCD graph. In one or more examples, the lower subset can comprise about the first 10 percent of data along the x-axis of a respective PCD graph.

Method 4:

METHOD 4
Pal-Score computation given PR Curve for a model

Inputs: Arrays of perturbation magnitude α[n] and accuracy [symbol] _{α}[n]
Output: Pal-score pαl
αₜ[0] ← 0 / / Initialize ist element of trapezoidal areas array with 0
for i ← 0 to n − 2 do
└ αₜ[i + 1] ← 0.5(αᵢ[i + 1] − α[i])( [symbol] _{α}[i] + [symbol] _{α}[i + 1])
top_idx ← index of 60% of α[n]
bottom_idx ← index of 10% of α[n]
pal ← αₜ[top_idx]/αₜ[bottom_idx]
return pαl

At Method 4, one or more processes can be performed to generate the Pal-score, such as by the analysis component 214. In the ‘for’ loop of this method, the area below the perturbation response curve and bounded between successive points along the horizontal axis is calculated. The index of the top x^{th} percentile (e.g., 60^{th} percentile) of the perturbation magnitude (normalized to a 0 to 1 scale) is obtained. The index of the bottom y^{th} percentile (e.g. 10^{th} percentile) of the perturbation magnitude (normalized to a 0 to 1 scale) is obtained. The output is a ratio of the area for the top x^{th} percentile and the bottom y^{th} percentile. Method 4 as written employs 60% as the top index and 10% as the bottom index, although different indices can be employed where suitable.

In one or more embodiments, only the Gi-score or only the Pal-score can be calculated by the AMAE system 202.

In one or more embodiments, less than all of the test set of data can be perturbed. For example, only one or more selected variables can be perturbed. In this way, the perturbed test data can be variant to the selected variable(s), and variance of the analytical model to the selected variable(s) can be estimated, using the aforedescribed processes.

Turning again back to FIG. 2, in one or more embodiments, the AMAE system 202 can comprise a training component 228 for training the analytical model 220. For example, based on one or more deviation scores, such as output by the analysis component 214, the analytical model 220 can be differently trained (as compared to training prior to analysis by the AMAE 202). In one or more embodiments, a regularization approach can be employed, using the PR and PCD curves generated based on the analytical model 220. For a batch of training data, when training the analytical model 220, a penalty can be added to the regularized model training loss function with some weight, such as by the analysis component 214, such as to influence/affect the training of the analytical model 220 by the training component 228. The penalty can be based on magnitude of deviation from the idealized PCD curve and/or based on magnitude of deviation from an average PCD curve. The average PCD curve can be based on plural PCD curve results from the analytical model 220 have executed using various input data sets. The various input data sets can be perturbed the same and/or differently.

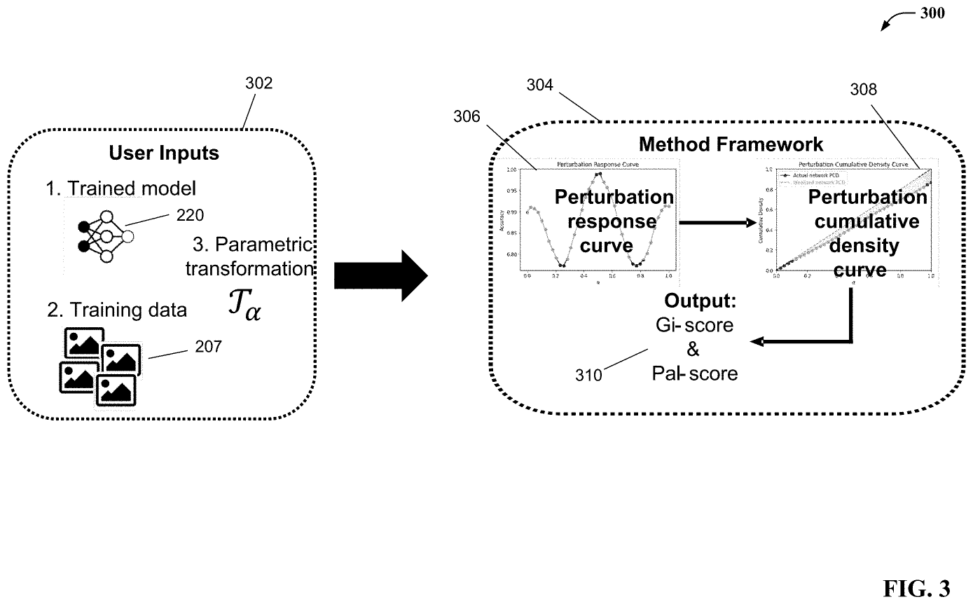

Turning next briefly to FIG. 3, a generalized illustration of one or more processes performed by the AMAE system 200 are illustrated at 300. At box 302, user inputs are illustrated. That is, a trained model, such as analytical model 220, training data (e.g., 207), and a parametric transformation (e.g., resulting in perturbed test data 207P) can be combined to output a measure of accuracy of the trained analytical model 220. At box 304, the perturbation curve 306 can be generated (e.g., by the deviation component 212), a perturbation cumulative density curve 308 can be generated (e.g., by the deviation component 212) and one or more deviation scores 310 can be output (e.g., by the analysis component 214).

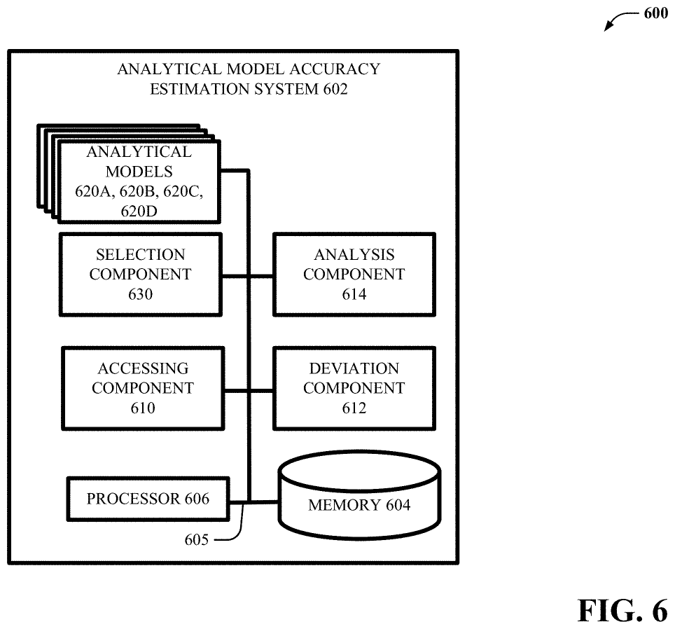

Turning now to FIG. 6, the figure illustrates a diagram of an example, non-limiting system 600 that can facilitate a process for determining a measure of accuracy of generalized use and/or particular use of an analytical model 220, in accordance with one or more embodiments described herein. Repetitive description of like elements and/or processes employed in respective embodiments is omitted for sake of brevity. Description relative to an embodiment of FIGS. 1 and/or 2 can be applicable to an embodiment of FIG. 6. Likewise, description relative to an embodiment of FIG. 6 can be applicable to an embodiment of FIGS. 1 and/or 2.

As illustrated, the non-limiting system 600 can comprise an analytical model accuracy estimation (AMAE) system 602 comprising a plurality of analytical models 602A, 602B, 602C and 602D. In one or more other embodiments, any one or more of the analytical models 602A to 602D can be disposed external to the AMAE system 602, such as at a database, repository and/or the like that is accessible by the AMAE system 602.

In one or more embodiments, the AMAE 602 likewise can comprise an analysis component 614, accessing component 610, deviation component 612, processor 606, memory 604, bus 605 and/or selection component 630.

Generally, AMAE system 602, in addition to facilitating accuracy estimation of one or more analytical models, can further facilitate selection of a model to employ for a particular situation and/or selection of a perturbation to employ for analyzing accuracy of one or more analytical models. For example, AMAE system 602, different from AMAE systems 102 and 202 can comprise a selection component 630, which can use and/or comprise an analytical model, such as an AI model, ML model and/or DL model for analyzing perturbations and/or analytical models.

Relative to analysis of analytical models, one or more analytical models can be stored internal and/or external to the AMAE system 602. Based on one or more relevant and/or selected factors, such as the Gi-score, the selection component can analyze at least a subset of the analytical models to determine one or more for use with a particular set of input data, such as provided by a user entity for analysis. In one or more embodiments, the selection component 630 and/or analysis component 614 can rank one or more analytical models relative to use with the particular set of input data, such as based on Gi-score, with lower Gi-score being more accurate.

Relative to analysis of perturbations, one or more perturbations, such as transformations and/or the like can be stored internal and/or external to the AMAE system 602. Based on one or more relevant and/or selected factors, the selection component 630 can analyze at least a subset of the perturbations known to the selection component 630 to determine one or more perturbations for use by the analysis component 614 in preparing test data. In one or more embodiments, the selection component 630 and/or analysis component 614 can rank one or more perturbations relative to use with a particular analytical model. In one or more embodiments, the determination component 608 can aid the selection component 630 by searching for unknown perturbations, such as on a selective, scheduled and/or other user entity-determined basis.

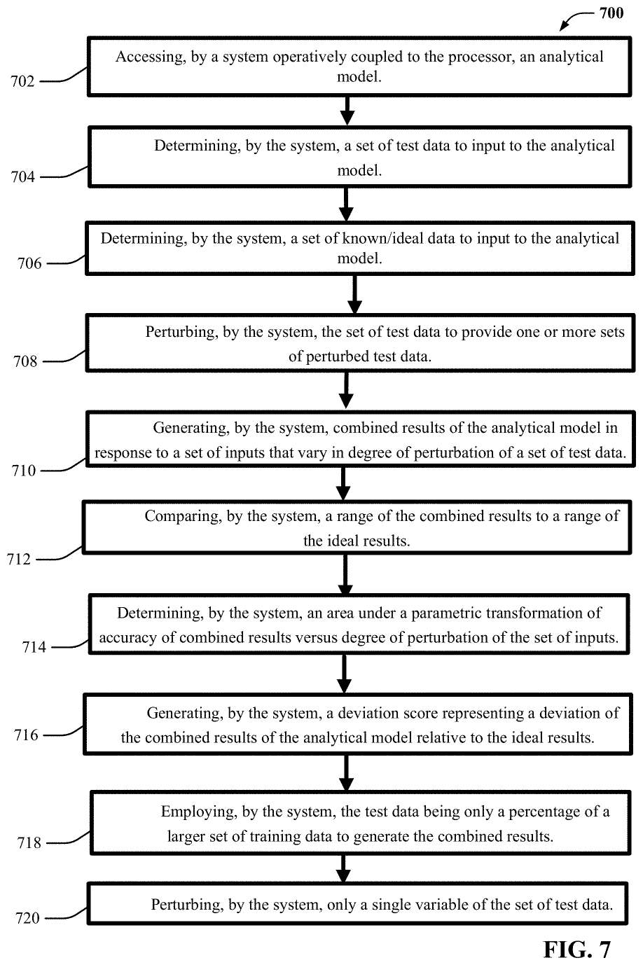

Next, FIG. 7 illustrates a flow diagram of an example, non-limiting method 700 that can facilitate analytical model classification, in accordance with one or more embodiments described herein, such as the non-limiting 200 of FIG. 2. While the non-limiting method 700 is described relative to the non-limiting system 200 of FIG. 2, the non-limiting method 700 can be applicable also to other systems described herein, such as the non-limiting system 100 of FIG. 1. Repetitive description of like elements and/or processes employed in respective embodiments is omitted for sake of brevity.

At 702, the non-limiting method 700 can comprise accessing, by a system operatively coupled to the processor (e.g., accessing component 210), an analytical model (e.g., analytical model 220).

At 704, the non-limiting method 700 can comprise determining, by the system (e.g., determination component 222) a set of test data (e.g., training data 207) to input to the analytical model.

At 706, the non-limiting method 700 can comprise determining, by the system (e.g., determination component 222) a set of known/ideal data (e.g., ideal/known data 211) to input to the analytical model.

At 708, the non-limiting method 700 can comprise perturbing, by the system (e.g., analysis component 214), the set of test data to provide one or more sets of perturbed test data (e.g., perturbed test data 207P).

At 710, the non-limiting method 700 can comprise generating, by the system (e.g., analytical model 220 and/or output component 224), combined results of the analytical model in response to a set of inputs that vary in degree of perturbation of a set of test data.

At 712, the non-limiting method 700 can comprise comparing, by the system (e.g., analysis component 214), a range of the combined results to a range of the ideal results.

At 714, the non-limiting method 700 can comprise determining, by the system (e.g., analysis component 214), an area under a parametric transformation of accuracy of combined results versus degree of perturbation of the set of inputs.

At 716, the non-limiting method 700 can comprise generating, by the system (e.g., deviation component 212), a deviation score representing a deviation of the combined results of the analytical model relative to the ideal results.

At 718, the non-limiting method 700 can comprise employing, by the system (e.g., analysis component 214), only a percentage of the set of test data to generate the combined results.

At 720, the non-limiting method 700 can comprise perturbing, by the system (e.g., analysis component 214), only a single variable of the set of test data.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, devices, computer program products and/or computer-implemented methods of use provided herein relate to classifying accuracy of analytical model, such as a neural network. A system can comprise a memory that stores computer executable components, and a processor that executes the computer executable components stored in the memory, wherein the computer executable components can comprise an accessing component that accesses an analytical model, a deviation component that generates combined results of the analytical model in response to a set of inputs that vary in degree of perturbation of a set of test data, and an analysis component that compares a range of the combined results to a range of the ideal results.

An advantage of the aforementioned systems, devices, computer program products and/or computer-implemented methods can be an ability to quantitively classify accuracy of an analytical model in a way that can generally relate to different models, different types of models, and/or the like, without the classification being reliant on particular explanation of resulting data/output of the analytical models. Furthermore, one or more analytical models can be classified based on different perturbations of input test data to gain a better understanding of how, why and/or where a particular analytical model deviates from a comparative idealized model that is unaffected by any such perturbations.

Indeed, in view of the one or more embodiments described herein, a practical application of the systems, computer-implemented methods and/or computer program products described herein can be efficient and intuitive accuracy classification of an analytical model. Overall, such computerized tools can constitute a concrete and tangible technical improvement in the field of analytical modelling, predictive modeling, forecasting, AI, ML, DL and/or active learning forecasting, without being limited thereto.

One or more embodiments described herein can be inherently and/or inextricably tied to computer technology and cannot be implemented outside of a computing environment. For example, one or more processes performed by one or more embodiments described herein can more efficiently, and even more feasibly, provide program and/or program instruction execution, such as relative to a computerized analytical model and an accuracy measure thereof, as compared to existing systems and/or techniques lacking such approach(es). Systems, computer-implemented methods and/or computer program products facilitating performance of these processes are of great utility in the field of computer-based modelling and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively generate, train, employ and/or analyze a computerized analytical model, as the one or more embodiments described herein can facilitate this process. And, neither can the human mind nor a human with pen and paper electronically effectively generate, train, employ and/or analyze a computerized analytical model, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

Turning next to FIGS. 8-10, a detailed description is provided of additional context for the one or more embodiments described herein at FIGS. 1-7.

FIG. 8 and the following discussion are intended to provide a brief, general description of a suitable operating environment 800 in which one or more embodiments described herein at FIGS. 1-7 can be implemented. For example, one or more components and/or other aspects of embodiments described herein can be implemented in or be associated with, such as accessible via, the operating environment 800. Further, while one or more embodiments have been described above in the general context of computer-executable instructions that can run on one or more computers, those skilled in the art will recognize that one or more embodiments also can be implemented in combination with other program modules and/or as a combination of hardware and software.

Generally, program modules include routines, programs, components, data structures and/or the like, that perform particular tasks and/or implement particular abstract data types. Moreover, the aforedescribed methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and/or the like, each of which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices and/or other tangible and/or non-transitory media which can be used to store specified information. In this regard, the terms “tangible” or “non-transitory” herein as applied to storage, memory and/or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set and/or changed in such a manner as to encode information in one or more signals. By way of example, but not limitation, communication media can include wired media, such as a wired network, direct-wired connection and/or wireless media such as acoustic, RF, infrared and/or other wireless media.

With reference still to FIG. 8, the example operating environment 800 for implementing one or more embodiments of the aspects described herein can include a computer 802, the computer 802 including a processing unit 806, a system memory 804 and/or a system bus 808. One or more aspects of the processing unit 806 can be applied to processors such as 106, 606 and/or 206 of the non-limiting systems 100 and/or 200. The processing unit 806 can be implemented in combination with and/or alternatively to processors such as 106, 606 and/or 206.

Memory 804 can store one or more computer and/or machine readable, writable and/or executable components and/or instructions that, when executed by processing unit 806 (e.g., a classical processor, a quantum processor and/or like processor), can facilitate performance of operations defined by the executable component(s) and/or instruction(s). For example, memory 804 can store computer and/or machine readable, writable and/or executable components and/or instructions that, when executed by processing unit 806, can facilitate execution of the one or more functions described herein relating to non-limiting system 100 and/or non-limiting system 200, as described herein with or without reference to the one or more figures of the one or more embodiments.

Memory 804 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures.

Processing unit 806 can comprise one or more types of processors and/or electronic circuitry (e.g., a classical processor, a quantum processor and/or like processor) that can implement one or more computer and/or machine readable, writable and/or executable components and/or instructions that can be stored at memory 804. For example, processing unit 806 can perform one or more operations that can be specified by computer and/or machine readable, writable and/or executable components and/or instructions including, but not limited to, logic, control, input/output (I/O), arithmetic and/or the like. In one or more embodiments, processing unit 806 can be any of one or more commercially available processors. In one or more embodiments, processing unit 806 can comprise one or more central processing unit, multi-core processor, microprocessor, dual microprocessors, microcontroller, System on a Chip (SOC), array processor, vector processor, quantum processor and/or another type of processor. The examples of processing unit 806 can be employed to implement one or more embodiments described herein.

The system bus 808 can couple system components including, but not limited to, the system memory 804 to the processing unit 806. The system bus 808 can comprise one or more types of bus structure that can further interconnect to a memory bus (with or without a memory controller), a peripheral bus and/or a local bus using one or more of a variety of commercially available bus architectures. The system memory 804 can include ROM 810 and/or RAM 812. A basic input/output system (BIOS) can be stored in a non-volatile memory such as ROM, erasable programmable read only memory (EPROM) and/or EEPROM, which BIOS contains the basic routines that help to transfer information among elements within the computer 802, such as during startup. The RAM 812 can include a high-speed RAM, such as static RAM for caching data.

The computer 802 can include an internal hard disk drive (HDD) 814 (e.g., EIDE, SATA), one or more external storage devices 816 (e.g., a magnetic floppy disk drive (FDD), a memory stick or flash drive reader, a memory card reader and/or the like) and/or a drive 820, e.g., such as a solid state drive or an optical disk drive, which can read or write from a disk 822, such as a CD-ROM disc, a DVD, a BD and/or the like. Additionally, and/or alternatively, where a solid state drive is involved, disk 822 could not be included, unless separate. While the internal HDD 814 is illustrated as located within the computer 802, the internal HDD 814 can also be configured for external use in a suitable chassis (not shown). Additionally, while not shown in operating environment 800, a solid state drive (SSD) can be used in addition to, or in place of, an HDD 814. The HDD 814, external storage device(s) 816 and drive 820 can be connected to the system bus 808 by an HDD interface 824, an external storage interface 826 and a drive interface 828, respectively. The HDD interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 812, including an operating system 830, one or more applications 832, other program modules 834 and/or program data 836. All or portions of the operating system, applications, modules and/or data can also be cached in the RAM 812. The systems and/or methods described herein can be implemented utilizing one or more commercially available operating systems and/or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In a related embodiment, operating system 830 can comprise one virtual machine (VM) of multiple VMs hosted at computer 802. Furthermore, operating system 830 can provide runtime environments, such as the JAVA runtime environment or the .NET framework, for applications 832. Runtime environments are consistent execution environments that can allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and/or settings for an application.

Further, computer 802 can be enabled with a security module, such as a trusted processing module (TPM). For instance, with a TPM, boot components hash next in time boot components and wait for a match of results to secured values before loading a next boot component. This process can take place at any layer in the code execution stack of computer 802, e.g., applied at application execution level and/or at operating system (OS) kernel level, thereby enabling security at any level of code execution.

An entity can enter and/or transmit commands and/or information into the computer 802 through one or more wired/wireless input devices, e.g., a keyboard 838, a touch screen 840 and/or a pointing device, such as a mouse 842. Other input devices (not shown) can include a microphone, an infrared (IR) remote control, a radio frequency (RF) remote control and/or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint and/or iris scanner, and/or the like. These and other input devices can be connected to the processing unit 806 through an input device interface 844 that can be coupled to the system bus 808, but can be connected by other interfaces, such as a parallel port, an IEEE 1394 serial port, a game port, a USB port, an IR interface, a BLUETOOTH® interface and/or the like.

A monitor 846 or other type of display device can be alternatively and/or additionally connected to the system bus 808 via an interface, such as a video adapter 848. In addition to the monitor 846, a computer typically includes other peripheral output devices (not shown), such as speakers, printers and/or the like.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device and/or other common network node, and typically includes many or all of the elements described relative to the computer 802, although, for purposes of brevity, only a memory/storage device 852 is illustrated. Additionally, and/or alternatively, the computer 802 can be coupled (e.g., communicatively, electrically, operatively, optically and/or the like) to one or more external systems, sources and/or devices (e.g., classical and/or quantum computing devices, communication devices and/or like device) via a data cable (e.g., High-Definition Multimedia Interface (HDMI), recommended standard (RS) 232, Ethernet cable and/or the like).

In one or more embodiments, a network can comprise one or more wired and/or wireless networks, including, but not limited to, a cellular network, a wide area network (WAN) (e.g., the Internet), or a local area network (LAN). For example, one or more embodiments described herein can communicate with one or more external systems, sources and/or devices, for instance, computing devices (and vice versa) using virtually any specified wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol and/or other proprietary and/or non-proprietary communication protocols. In a related example, one or more embodiments described herein can include hardware (e.g., a central processing unit (CPU), a transceiver, a decoder, quantum hardware, a quantum processor and/or the like), software (e.g., a set of threads, a set of processes, software in execution, quantum pulse schedule, quantum circuit, quantum gates and/or the like) and/or a combination of hardware and/or software that facilitates communicating information among one or more embodiments described herein and external systems, sources and/or devices (e.g., computing devices, communication devices and/or the like).

The logical connections depicted include wired/wireless connectivity to a local area network (LAN) 854 and/or larger networks, e.g., a wide area network (WAN) 856. LAN and WAN networking environments can be commonplace in offices and companies and can facilitate enterprise-wide computer networks, such as intranets, all of which can connect to a global communications network, e.g., the Internet.

When used in a LAN networking environment, the computer 802 can be connected to the local network 854 through a wired and/or wireless communication network interface or adapter 858. The adapter 858 can facilitate wired and/or wireless communication to the LAN 854, which can also include a wireless access point (AP) disposed thereon for communicating with the adapter 858 in a wireless mode.

When used in a WAN networking environment, the computer 802 can include a modem 860 and/or can be connected to a communications server on the WAN 856 via other means for establishing communications over the WAN 856, such as by way of the Internet. The modem 860, which can be internal and/or external and a wired and/or wireless device, can be connected to the system bus 808 via the input device interface 844. In a networked environment, program modules depicted relative to the computer 802 or portions thereof can be stored in the remote memory/storage device 852. The network connections shown are merely exemplary and one or more other means of establishing a communications link among the computers can be used.

When used in either a LAN or WAN networking environment, the computer 802 can access cloud storage systems or other network-based storage systems in addition to, and/or in place of, external storage devices 816 as described above, such as but not limited to, a network virtual machine providing one or more aspects of storage and/or processing of information. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, such as with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices and/or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf and/or the like). This can include Wireless Fidelity (Wi-Fi) and BLUETOOTH® wireless technologies. Thus, the communication can be a predefined structure as with a conventional network or simply an ad hoc communication between at least two devices.

The illustrated embodiments described herein can be employed relative to distributed computing environments (e.g., cloud computing environments), such as described below with respect to FIG. 10, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment 1950 described below with reference to illustration 900 of FIG. 9, and/or with reference to the one or more functional abstraction layers (e.g., quantum software and/or the like) described below with reference to FIG. 10, to execute one or more operations in accordance with one or more embodiments described herein. For example, cloud computing environment 950 and/or one or more of the functional abstraction layers 1060, 1070, 1080 and/or 1090 can comprise one or more classical computing devices (e.g., classical computer, classical processor, virtual machine, server and/or the like), quantum hardware and/or quantum software (e.g., quantum computing device, quantum computer, quantum processor, quantum circuit simulation software, superconducting circuit and/or the like) that can be employed by one or more embodiments described herein and/or components thereof to execute one or more operations in accordance with one or more embodiments described herein. For instance, one or more embodiments described herein and/or components thereof can employ such one or more classical and/or quantum computing resources to execute one or more classical and/or quantum: mathematical function, calculation and/or equation; computing and/or processing script; algorithm; model (e.g., artificial intelligence (AI) model, machine learning (ML) model and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines and/or services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can specify location at a higher level of abstraction (e.g., country, state and/or datacenter).

Rapid elasticity: capabilities can be rapidly and elastically provisioned, in one or more cases automatically, to quickly scale out and rapidly released to quickly scale in. To the consumer, the capabilities available for provisioning can appear to be unlimited and can be purchased in any quantity at any time.

Measured service: cloud systems automatically control and optimize resource use by leveraging a metering capability at one or more levels of abstraction appropriate to the type of service (e.g., storage, processing, bandwidth and/or active user accounts). Resource usage can be monitored, controlled and/or reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage and/or individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems and/or storage, but has control over the deployed applications and possibly application hosting environment configurations.

Infrastructure as a Service (IaaS): the capability provided to the consumer is to provision processing, storage, networks and/or other fundamental computing resources where the consumer can deploy and run arbitrary software, which can include operating systems and applications. The consumer does not manage or control the underlying cloud infrastructure but has control over operating systems, storage, deployed applications and/or possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy and/or compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community or public) that remain unique entities but are bound together by standardized or proprietary technology that enables data and application portability (e.g., cloud bursting for load-balancing among clouds).

A cloud computing environment is service oriented with a focus on statelessness, low coupling, modularity and/or semantic interoperability. At the heart of cloud computing is an infrastructure that includes a network of interconnected nodes.

Moreover, the non-limiting system 100 and/or the example operating environment 800 can be associated with and/or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system and/or the like. In accordance therewith, non-limiting system 100 and/or example operating environment 800 can be employed to use hardware and/or software to solve problems that are highly technical in nature, that are not abstract and/or that cannot be performed as a set of mental acts by a human.

Referring now to details of one or more aspects illustrated at FIG. 9, the illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C and/or automobile computer system 954N can communicate. Although not illustrated in FIG. 9, cloud computing nodes 910 can further comprise a quantum platform (e.g., quantum computer, quantum hardware, quantum software and/or the like) with which local computing devices used by cloud consumers can communicate. Cloud computing nodes 910 can communicate with one another. They can be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that cloud computing nodes 910 and cloud computing environment 950 can communicate with any type of computerized device over any type of network and/or network addressable connection (e.g., using a web browser).

Referring now to details of one or more aspects illustrated at FIG. 10, a set 1000 of functional abstraction layers is shown, such as provided by cloud computing environment 950 (FIG. 19). One or more embodiments described herein can be associated with, such as accessible via, one or more functional abstraction layers described below with reference to FIG. 10 (e.g., hardware and software layer 1060, virtualization layer 1070, management layer 1080 and/or workloads layer 1090). It should be understood in advance that the components, layers and/or functions shown in FIG. 10 are intended to be illustrative only and embodiments described herein are not limited thereto. As depicted, the following layers and/or corresponding functions are provided:

Hardware and software layer 1060 can include hardware and software components. Examples of hardware components include: mainframes 1061; RISC (Reduced Instruction Set Computer) architecture-based servers 1062; servers 1063; blade servers 1064; storage devices 1065; and/or networks and/or networking components 1066. In one or more embodiments, software components can include network application server software 1067, quantum platform routing software 1068; and/or quantum software (not illustrated in FIG. 10).

Virtualization layer 1070 can provide an abstraction layer from which the following examples of virtual entities can be provided: virtual servers 1071; virtual storage 1072; virtual networks 1073, including virtual private networks; virtual applications and/or operating systems 1074; and/or virtual clients 1075.

In one example, management layer 1080 can provide the functions described below. Resource provisioning 1081 can provide dynamic procurement of computing resources and other resources that can be utilized to perform tasks within the cloud computing environment. Metering and Pricing 1082 can provide cost tracking as resources are utilized within the cloud computing environment, and/or billing and/or invoicing for consumption of these resources. In one example, these resources can include one or more application software licenses. Security can provide identity verification for cloud consumers and/or tasks, as well as protection for data and/or other resources. User (or entity) portal 1083 can provide access to the cloud computing environment for consumers and system administrators. Service level management 1084 can provide cloud computing resource allocation and/or management such that required service levels are met. Service Level Agreement (SLA) planning and fulfillment 1085 can provide pre-arrangement for, and procurement of, cloud computing resources for which a future requirement is anticipated in accordance with an SLA.

Workloads layer 1090 can provide examples of functionality for which the cloud computing environment can be utilized. Non-limiting examples of workloads and functions which can be provided from this layer include: mapping and navigation 1091; software development and lifecycle management 1092; virtual classroom education delivery 1093; data analytics processing 1094; transaction processing 1095; and/or application transformation software 1096.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an accessing component that accesses an analytical model;
a deviation component that generates combined results of the analytical model in response to a set of inputs that vary in degree of perturbation of a set of test data; and
an analysis component that compares a range of the combined results to a range of the ideal results.

2. The system of claim 1, wherein the analysis component further generates a deviation score representing a deviation of the combined results of the analytical model relative to the ideal results.

3. The system of claim 2, wherein the deviation score comprises a comparison of a parametric transformation comprising the combined results and of a parametric transformation comprising the ideal results.

4. The system of claim 1, wherein the deviation component perturbates only a single variable of the set of test data.

5. The system of claim 1, wherein to compare the combined results to the ideal results, the analysis component determines an area under a parametric transformation of accuracy of combined results versus degree of perturbation of the set of inputs.

6. The system of claim 1, wherein the ranges of the compared combined results and the ideal results comprise less than all of the combined results and the ideal results.

7. The system of claim 1, wherein the system employs the test data being only a percentage of a larger set of training data to generate the combined results.

8. A computer-implemented method, comprising:
accessing, by a system operatively coupled to the processor, an analytical model;
generating, by the system, combined results of the analytical model in response to a set of inputs that vary in degree of perturbation of a set of test data; and
comparing, by the system, a range of the combined results to a range of the ideal results.

9. The computer-implemented method of claim 8, further comprising:
generating, by the system, a deviation score representing a deviation of the combined results of the analytical model relative to the ideal results.

10. The computer-implemented method of claim 9, wherein the deviation score comprises a comparison of a parametric transformation comprising the combined results and of a parametric transformation comprising the ideal results.

11. The computer-implemented method of claim 8, further comprising:
perturbing, by the system, only a single variable of the set of test data.

12. The computer-implemented method of claim 8, further comprising:
determining, by the system, an area under a parametric transformation of accuracy of combined results versus degree of perturbation of the set of inputs.

13. The computer-implemented method of claim 8, wherein the ranges of the compared combined results and the ideal results comprise less than all of the combined results and the ideal results.

14. The computer-implemented method of claim 8, further comprising:
employing, by the system, the test data being only a percentage of a larger set of training data to generate the combined results.

15. A computer program product facilitating a process to classify accuracy of an analytical model, the computer program product comprising a computer readable storage medium having program instructions embodied therewith, the program instructions executable by a processor to cause the processor to:
access, by the processor, the analytical model;
generate, by the processor, combined results of the analytical model in response to a set of inputs that vary in degree of perturbation of a set of test data; and
compare, by the processor, a range of the combined results to a range of the ideal results.

16. The computer program product of claim 15, wherein the program instructions are further executable by the processor to:
generate, by the processor, a deviation score representing a deviation of the combined results of the analytical model relative to the ideal results.

17. The computer program product of claim 16, wherein the deviation score comprises a comparison of a parametric transformation comprising the combined results and of a parametric transformation comprising the ideal results.

18. The computer program product of claim 15, wherein the program instructions are further executable by the processor to:
perturb, by the processor, only a single variable of the set of test data.

19. The computer program product of claim 15, wherein the program instructions are further executable by the processor to:
determine, by the processor, an area under a parametric transformation of accuracy of combined results versus degree of perturbation of the set of inputs.

20. The computer program product of claim 15, wherein the ranges of the compared combined results and the ideal results comprise less than all of the combined results and the ideal results.
